(19) United States
(12) Patent Application Publication
(10) Pub. No.: US 2006/0244773 A1
(43) Pub. Date: Nov. 2, 2006

(54) Printing method and printer used for applying the method

(75) Inventor: Hermanus M.A. Wijshoff, Grevenbicht (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/411,894

(22) Filed: Apr. 27, 2006

(30) Foreign Application Priority Data
Apr. 28, 2005 (EP) 05103516.0

(51) Int. Cl. B41J 29/38

(52) U.S. Cl. 347/11

(57) ABSTRACT

A method and device for transferring ink to a receiving material using an inkjet printer having an ink chamber with a nozzle and an electromechanical transducer in cooperative connection with the ink chamber, wherein the transducer is actuated to generate a pressure wave in the ink chamber to expel a volume of ink from the nozzle, the pressure wave being such that it induces splitting of the ink volume into a first and second ink droplet, wherein the transducer is actuated such that the volume of ink that is forced to be expelled from the ink chamber experiences a supercritical acceleration in the direction of the receiving material, whereafter the transducer is actuated to retract the second droplet into the ink chamber.

This application claims priority to European Patent Application No. 05103516.0 filed on Apr. 28, 2005, the entire contents of which is hereby incorporated by reference in its entirety.

### BACKGROUND OF THE INVENTION

The present invention pertains to a method for transferring ink to a receiving material using an inkjet printer having an ink chamber with a nozzle and an electromechanical transducer in cooperative connection with the ink chamber, which comprises actuating the transducer to generate a pressure wave in the ink chamber to expel a volume of ink from the nozzle, the pressure wave being such that it induces splitting of the said volume in a first and second ink droplet. The present invention also pertains to a printhead that is suitable for applying the present method, as well as a printer that is provided with this printhead.

Such a method is known from the United States patent U.S. Pat. No. 6,406,116. In this patent an inkjet printer is of the piezo type. Such a printer comprises an ejection printhead having multiple substantially closed ink cambers, each having an inlet for feeding liquid ink into the chamber and a nozzle for ejecting ink droplets from this chamber. Each of the ink chambers is in operative connection with a piezoelectric element. In the known printer, each of these piezoelectric elements is in contact with a corresponding ink chamber. The element is capable of deforming by the application of a voltage (called actuating) and in this way implements an extremely high-speed conversion of electrical energy into mechanical energy. Such deformation, being an expansion, shrinkage or a combination of both, serves to suddenly change the volume of the ink chamber, thus inducing a pressure wave in this chamber. As is commonly known, such a pressure wave can serve to expel a volume of ink from the nozzle. From the above-mentioned patent it is known to generate a pressure wave such that the volume of ink is provided with local speed differences. This is applied to create a so-called split ink droplet. Ejection of a volume of ink with a local speed difference changes the shape of the volume of ink according to the degree of the speed difference and thus enables the creation of droplets in various states. This ejection method enables the creation of ink dots on the receiving material having different areas of coverage. This enables on its turn a plurality of different densities to be expressed with regard to each picture element (pixel), thus ensuring smooth tone expression and improving overall image quality, especially in the low tone image areas.

However, the known method has an important disadvantage. The quantity of ink that is expelled per ink ejection is substantially the same as compared to the prior art. Thus, even if the volume of ink is split into to or more droplets, each droplet will hit the receiving material at substantially the same location. This means, that the ultimate densities of the picture elements do not differ that much from the densities where the volume of ink would not have been split. Next to this, the problem of low duty restrictions of many receiving materials (i.e., a low upper limit in the quantity of ink absorbable per unit area), which might be mitigated by expelling smaller ink droplets, is not solved by the known printing method. Namely, the same amount of ink is still jetted onto the receiving material per ink ejection. Lastly, the advantage of varying ink droplet sizes, which in principle enables a richer color expression of the printed images, cannot be harvested to the full extent because each small droplet is automatically accompanied by a big droplet or multiple smaller droplets. Thus, the same amount of ink is used per picture element or at least per area that comprises the picture element.

### SUMMARY OF THE INVENTION

It is an object of the present invention to overcome or at least mitigate the above-mentioned problems. To this end, a method according to the present invention has been developed wherein the transducer is actuated such that the volume of ink that is forced to be expelled from the ink chamber experiences a supercritical acceleration in the direction of the receiving material, whereafter the transducer is actuated to retract the second droplet into the ink chamber.

This method makes use of the recognition that the part of the ink volume that is, or is going to become the second droplet (i.e., the droplet being closest to the nozzle itself) can be retracted back into the ink chamber by adequately reducing the pressure at the nozzle. This pressure reduction should not be imposed too early in order to prevent the retraction of the first droplet back into the ink chamber. Nor should the pressure reduction be imposed too late, i.e., at a time where the second droplet can no longer be retracted. The method according to the present invention has the important advantage that the first droplet can be selected to be the only droplet (of this particular ink ejection) that is actually ejected in order to become part of the image on the receiving medium. In this way, the advantages of drop size modulation can be fully harvested, even with an ink jet head that is originally developed for creating ink droplets of only one (relatively big) size. With the present method ink droplets of various sizes can be created without each droplet being accompanied by one or more droplets, together still having a volume that is equivalent to one big droplet as known from the prior art methods. For example, from the above-mentioned US patent it is known how to create first droplets with varying sizes. By applying the pressure reduction of the present invention, the accompanying trailing droplet(s) can be effectively retracted in the ink chamber, thus leaving only the first droplet to become part of the image to be formed on the receiving material. This enables image formation with a very smooth tone expression.

The present invention further relies on the feature that the pressure wave is such that the volume of ink experiences a supercritical acceleration in the direction of the receiving material. The initial volume of ink that is induced to be expelled from the ink chamber is accelerated such that the surface tension of the ink is no longer capable of keeping the volume completely together. A supercritical acceleration provides for relatively large speed differences within the volume of ink, the speed differences being such that the forces to split the volume are no longer balanced by the surface tension forces. The advantage of a supercritical acceleration is that the speed differences are relatively high when the volume of ink is still in or at least near the nozzle. This means that the step of retracting the second droplet is relatively easy. The second droplet (i.e., at least that part of the volume of ink that is induced to become the second droplet) is often still almost completely present at the nozzle when the requirements for separation of the volume of ink into two individual droplets have already been fulfilled. Note that at this stage the individual droplets need not have been formed yet, it is sufficient that the local speed differences within the volume have become so high that (without any further action) two individual droplets will arise. A supercritical acceleration thus virtually guarantees that the retraction process is 100% reliable, thus further improving the image quality.

Another advantage of such a supercritical acceleration is that the method can be applied also with ink having a relatively large viscosity, thus enabling, for example, the use at relatively low operating temperatures. Next to this, it appears that application of a supercritical acceleration enables the splitting of a very small volume of ink, so that extreme small ink droplets can be provided for.

It is noted that application of a supercritical acceleration can be imposed by various methods as is known from the prior art. This kind of acceleration for example takes place when satellite ink drops are formed. This process is known from the prior art but is generally regarded as undesirable. For example, it is known that when the pressure increase at the nozzle becomes too high (or increases too fast) because of a too small nozzle cross section when compared to the ink chamber cross section, this gives rise to leading satellite ink drops in front of the main ink droplet. Also, when the meniscus of the ink in the ink chamber is retracted too fast before a sudden pressure increase in the ink chamber, this can give rise to satellite ink drops. In this case namely almost all acceleration energy is put into a very small volume of ink that thus experiences a super critical acceleration. Satellite drops can also appear when the pressure increase at the nozzle is very high as the result of specific reflections of the pressure wave at the nozzle location. It is, for example, known that if the piezoelectric element is located somewhat distant from the nozzle, this can give rise to such reflections.

From U.S. Pat. No. 6,513,894 it is known that a pressure wave can be generated in the ink chamber that induces splitting of the volume of ink to be expelled in a first and second ink droplet, and that the second droplet can be retracted back into the ink chamber. However, this method relies on the generation of oscillations in the volume of ink to provide for the splitting effect. This method has the disadvantage that it is less reliable and can only be applied with inks that have a very low viscosity (typically water and solvent based inks). Moreover, adequate oscillations can only be generated in relatively large volumes of ink. The known method therefore has several disadvantages that have been overcome or at least mitigated by the present invention.

In one embodiment the ink that is being used is substantially free of solvent. Such an ink comprises for example less than 5% of solvent, preferably even less than 2%. This provides for the advantage that substantially all jetted ink is incorporated in the ultimate image. Inks comprising solvents such as water based inks, suffer from the need to evaporate the solvent. Inks that are substantially free of solvent, such as hot melt inks or many UV-curable inks do not require the evaporation of solvent. However, such inks typically have a relatively high viscosity (typical 10 mPa·s at operating temperature) which severely reduces the amount of freedom in applying adequate pressure waves to expel droplets of these inks. In particular, commonly known strategies to provide for drop size modulation (that is, being able to provide for ink droplets of various sizes) are only effective for inks having very low viscosities (less than 5 mPa·s). It appears that the present method is extremely suitable to render true drop size modulation for inks that have a relatively high viscosity at operating temperatures. Creating the effect of droplet splitting appears to be relatively simple for these high viscosity inks, which also is the case for the creation of a sufficient pressure reduction to retract the second droplet.

The present invention also pertains to an inkjet printhead for transferring ink to a receiving material, the head comprising an ink chamber with a nozzle and an electromechanical transducer in cooperative connection with the said ink chamber and a driving unit for controlling the actuation of the transducer. The driving unit is programmed such that it is capable of actuating the transducer to generate a pressure wave in the ink chamber to expel a volume of ink from the nozzle, the pressure wave being such that it induces splitting of said volume into a first and second ink droplet. The driving unit is further capable of actuating the transducer such that the volume of ink that is forced to be expelled from the ink chamber experiences a supercritical acceleration in the direction of the receiving material. After this, the transducer is actuated to retract the second droplet back into the ink chamber. A printer that is provided with such a printhead is also part of the present invention.

### BRIEF DESCRIPTION OF THE DRAWINGS

The present invention will be further explained with reference to the following drawings and examples given here-beneath.

FIG. 1 is a schematic representation of an inkjet printer.

FIG. 2 schematically shows a portion of a piezo-electrically driven inkjet printhead.

FIG. 3 diagrammatically shows a pressure variation at the nozzle of an ink chamber.

FIG. 4 shows a droplet forming process.

### DETAILED DESCRIPTION OF THE INVENTION

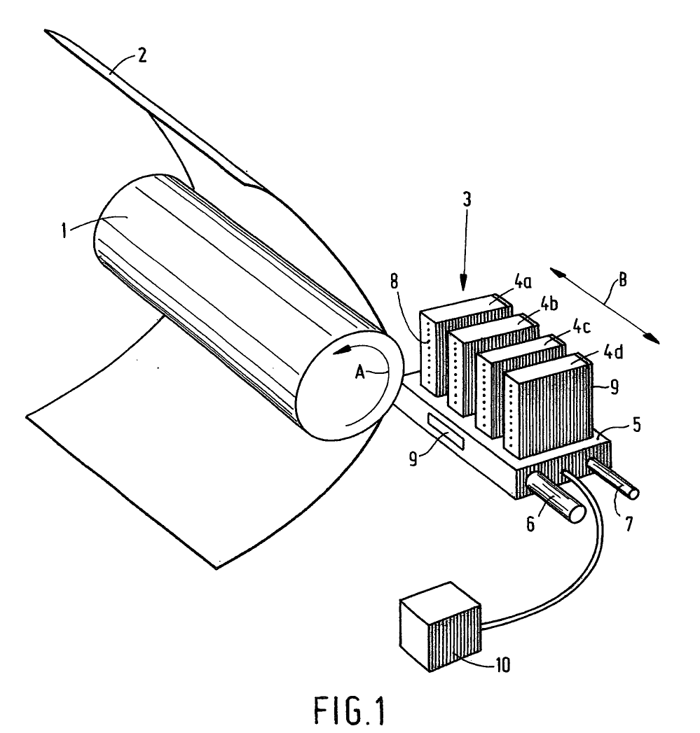

FIG. 1 diagrammatically illustrates an inkjet printer. In this embodiment, the printer comprises a roller 1 for supporting a receiving material 2, for example a sheet of paper or a transparent sheet, and moving it along the scanning carriage 3. The carriage comprises a support member 5 on which the four printheads 4a, 4b, 4c and 4d are fixed. Each printhead is provided with ink having its own color, in this case respectively, cyan (C), magenta (M), yellow (Y) and black (K). The printheads are specially designed for jetting solvent free ink. For this to be possible, the heads are heated by a heater that utilizes heating elements 9 disposed at the back of each printhead 4 and on the support member 5. These heating elements ensure that the temperature of the printheads is high enough to provide for an adequate (low) viscosity of the ink in the ink chambers. The printhead itself is at least partially made of materials with excellent heat conduction such that it is possible for the heater to substantially, uniformly heat the ink in the ink chambers (not shown). Temperature sensors (not shown) are also provided. The printheads are maintained at the correct temperature via a control unit that is incorporated in controller 10, by means of which the heating means can be individually actuated in dependence on the temperature measured by the sensors. Since the printheads are subjected to many heating and cooling cycles, the materials of which the printheads are made are well matched with respect to their thermal expansion coefficients. Next to this, all mechanical connections are designed to be able to resist the tensions that are due to the temperature changes.

The roller 1 is rotatable about its axis as indicated by arrow A. In this way, the receiving material can be moved in the sub-scanning direction (X-direction) with respect to the support member 5 and hence also with respect to the printheads 4. The carriage 3 can be moved in reciprocation by suitable drive means (not shown) in a direction indicated by the double arrow B, parallel to the roller 1. For this purpose, the support member 5 is moved over the guide rods 6 and 7. This direction is termed the main scanning direction or Y-direction. In this way the receiving material can be completely scanned with the printheads 4. In the embodiment as shown in FIG. 1, each printhead 4 contains a number of print elements each provided with an ink chamber (not shown) having their own nozzle 8. In this embodiment, the nozzles form for each printhead one row which extends perpendicular to the axis of roller 1 (sub-scanning direction). In a practical embodiment of the inkjet printer, the number of ink chambers per printhead will be many times larger and the nozzles are distributed over two or more rows. Each ink chamber is provided with an electromechanical transducer (not shown) whereby the pressure in the ink duct can be suddenly increased so that an ink drop is ejected through the nozzle of the associated chamber in the direction of the receiving material. A device of this kind can be, for example, a piezo-electric element. Such a device can be energized image-wise via an associated electric drive circuit (not shown). In this way an image built up from ink drops can be formed on receiving material 2.

When a receiving material is printed with a printer of this kind, wherein ink drops are ejected by the print elements, said receiving material or a part thereof is (imaginarily) divided up into fixed locations which form a regular field of pixel rows and pixel columns. In one embodiment, the pixel rows are perpendicular to the pixel columns. The resulting separate locations can each be provided with one or more ink drops. The number of locations per unit length in the directions parallel to the pixel rows and pixel columns is termed the resolution of the printed image, for example indicated as 400×600 d.p.i. (“dots per inch”). By actuating a row of nozzles of a printhead of the inkjet printer image-wise, when the row moves with respect to the receiving material with displacement of the support member 5, a (part-)image built up from ink drops forms on the receiving material, at least on a strip of a width of the length of the nozzle row.

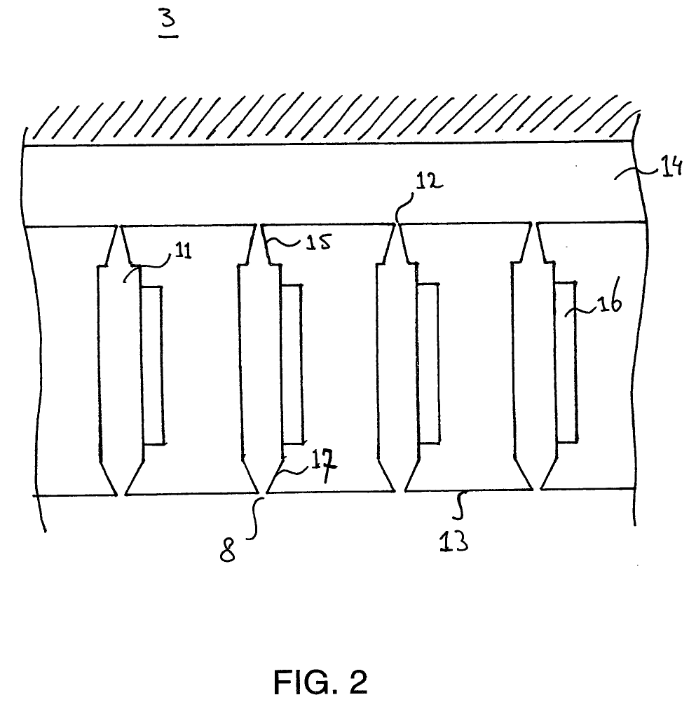

FIG. 2 schematically shows a portion of the piezo-electrically driven inkjet printhead 3. The structure depicted in FIG. 2 comprises four ink chambers 11 that under operating conditions contain the printing ink, in this case an adequately liquified hot melt ink. At one end of the ink chamber an outlet 17 is provided, which extends between the ink chamber and a nozzle 8 provided in the front end 13 of the ink jet head. At the other end, the ink chamber 11 is connected to an ink supply reservoir 14 which serves to supply the ink chambers with new ink. The individual ink chambers are connected to the ink supply reservoir via an inlet 15. Each of the ink chambers 11 is connected to a piezo-electric transducer 16. This transducer can be actuated whereupon it shrinks or expands.

In this way, by transferring that movement to the ink in the corresponding ink chamber, pressure waves can be generated in the ink as is commonly known in the art, e.g. from U.S. Pat. No. 4,688,048 (reference is hereby made to all figures and corresponding description of this US patent). As a result of these pressure waves, a droplet of ink can be jetted out of the nozzle. The actuation itself, i.e., how the piezoelectric element is deformed, is controlled by a driving unit comprising a pulse generator and controlling hard- and software, which driving unit is incorporated in controller 10 (see FIG. 1). After the ejection of an ink droplet, the same amount of ink is fed from ink reservoir 14 to the corresponding ink chamber. The small opening 12 of inlet 15 almost completely prevents the generated pressure waves to propagate to neighbouring ink chambers via the common ink supply reservoir.

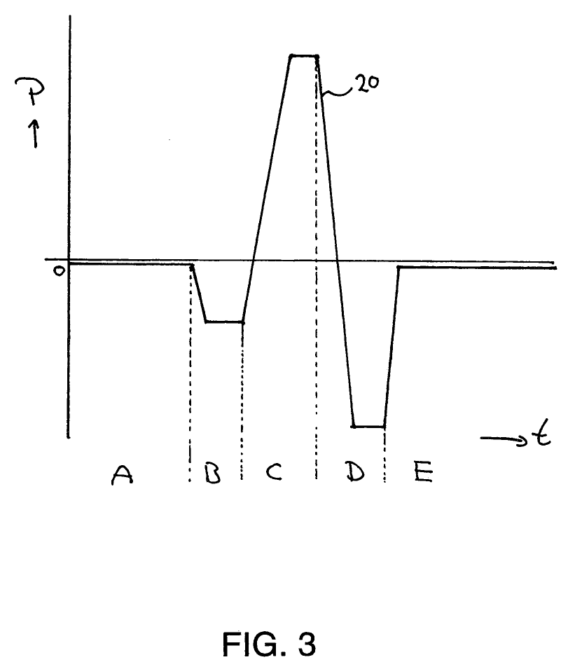

FIG. 3 diagrammatically shows a pressure variation at the nozzle of an ink chamber. Graph 20 shows the pressure P in the nozzle (Y-axis, arbitrary units) as a function of the time t (X-axis, arbitrary units). Segment A of graph 20 reflects the minimal negative pressure P in an ink chamber which is at rest. This minimal negative pressure prevents ink from dripping out of the nozzle. In segment B, the pressure is suddenly decreased by shrinking the corresponding piezo-electric transducer. After that, it can be seen that the pressure is increased in section C. This relatively strong and sudden pressure increase induces a supercritical acceleration of the volume of ink that is present in the nozzle. This pressure increase is followed by a big decrease of the pressure in segment D. This decrease takes care of retraction of the trailing part the accelerated ink volume. Lastly, the pressure is brought back again to its initial value in segment E.

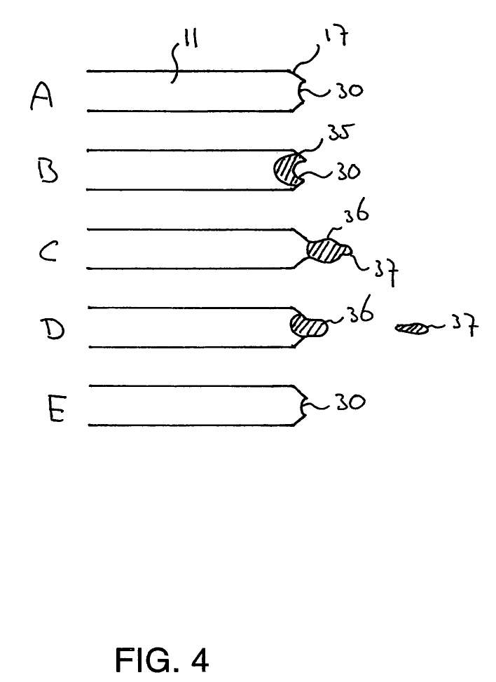

FIG. 4 shows the droplet forming process when applying the pressure variations as depicted in FIG. 3. With respect to segment A in graph 20, it can be seen that the meniscus 30 of the ink in the nozzle 17 of ink chamber 11 is somewhat concave due to the slight negative pressure in the ink chamber. In segment B, this meniscus is retracted into the ink chamber due to the sudden pressure decrease. This affects mainly the ink volume 35 at the nozzle 17. This pressure decrease is followed by a supercritical acceleration in segment C. Due to this supercritical acceleration, ink volume 35 is expelled out of nozzle 17 and splitting of the volume 35 in two parts 36 and 37 is induced. The first part 36 has a somewhat lower speed than the second part 37. Would there be no further pressure change, then the parts 36 and 37 would split completely and form individual ink droplets. However, in segment D, a very large pressure decrease is provided for which retracts part 36 almost completely back into the ink chamber. Part 37 has gained already so much speed that the surface tension of the ink can not overcome the moment of inertia of this part 37 which thus becomes an individual ink droplet 37. In segment E, the pressure is brought back to its initial value which enables the meniscus of the ink to take its starting position again. The result of this process is that a relatively small droplet of hot melt ink is jetted out of the nozzle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for transferring ink to a receiving material using an inkjet printer having an ink chamber with a nozzle and an electromechanical transducer in cooperative connection with the ink chamber, which comprises actuating the transducer to generate a pressure wave in the ink chamber to expel a volume of ink from the nozzle, the pressure wave being such that it induces splitting of said volume in to a first and second ink droplet, wherein the transducer is actuated such that the volume of ink that is forced to be expelled from the ink chamber experiences a supercritical acceleration in the direction of the receiving material, whereafter the transducer is actuated to retract the second droplet into the ink chamber.

2. The method according to claim 1, wherein the ink is substantially free of solvent.

3. An inkjet printhead for transferring ink to a receiving material, said print head comprising an ink chamber with a nozzle and an electromechanical transducer in cooperative connection with the said ink chamber, and a driving unit for controlling the actuation of the transducer, said driving unit being programmed such that it is capable of actuating the transducer to generate a pressure wave in the ink chamber to expel a volume of ink from the nozzle, the pressure wave being such that it induces splitting of the said ink volume into a first and second ink droplet, the driving unit being capable of actuating the transducer such that the volume of ink that is forced to be expelled from the ink chamber experiences a supercritical acceleration in the direction of the receiving material, and subsequently the transducer is actuated to retract the second droplet back into the ink chamber.

4. A printer provided with a printhead according to claim 3.
